(19) United States
(12) Patent Application Publication
(10) Pub. No.: US 2007/0150820 A1
(43) Pub. Date: Jun. 28, 2007

(54) Data-driven user interface

(76) Inventor: Anthony Charles Salvo, Westford, MA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/316,478

(22) Filed: Dec. 22, 2005

(51) Int. Cl. G06F 9/00; G06F 3/00

(52) U.S. Cl. 715/760; 715/762; 715/810; 715/764

(57) ABSTRACT

A system for generating a data-driven user interface. The system comprises a network interface configured to communicate with a user device, a processor coupled to the network interface, and a memory coupled to the processor. The memory contains a product model, user-interface logic, and metadata. User interface specific metadata drives the user-interface logic to generate a dynamic user interface. The user-interface metadata defers to and is bound to the product model and comprises various abstractions including an item, set, frame and flow. A flow is responsive to one or more rules and defines a transition from a first frame to a subsequent frame.

### BACKGROUND

For almost as long as computers have existed, their designers and users have sought improvements to the user interface. As computing power has increased, a greater portion of the available processing capacity has been devoted to improved interface design. Traditional human computer interfaces have emphasized uniformity and consistency, thus, experienced users had a shortened learning curve for use of software and systems; while novice users often required extensive instruction before they developed a desired proficiency with a particular interface system. Recent examples have been Microsoft Windows® variants and Internet web browsers. Microsoft Windows® is the registered trademark of the Microsoft Corporation of Redmond, Wash., U.S.A. These graphical user interfaces provide significant flexibility to present data using various paradigms.

Some application interfaces operable under one or more of the Microsoft Windows® operating systems vary in response to user action while a user is interacting with an interface. Of these, the application interfaces vary in accordance with the data being manipulated by the program and/or one or more configuration parameters. For example, in the popular word-processing application Microsoft Word, the “Edit” drop-down menu will inactivate one or more of the “Cut,” “Copy,” “Links,” and “Objects” options when the user has not selected a string of text, a link is not present within the present document, and when an object has not been inserted into the present document. The above-described inactive menu options are responsive to the data being manipulated. In the popular e-mail application Microsoft Outlook, the “View” drop-down menu includes configuration options of “Folder list” and “Preview pane.” When the “Folder list” configuration option is enabled, the Outlook application interface presents a frame with a graphical representation of one or more folders that the present user of the application has created to store e-mail messages. When the “Preview pane” configuration option is enabled, the Outlook application interface presents both the present user's inbox in a first frame and the contents of a select e-mail message in a second frame of the interface. The above-described manipulation of frames is an example of an interface responsive to configuration options.

In addition, a number of application programs for communication and navigation on the world-wide-web are in common use, such as Netscape Navigator and Microsoft Internet Explorer. These programs or browsers communicate with remote computer systems via the Internet or other computer networks. When executed, the browser software causes the computer to operate a network communication device such as a modem. When browsing the world-wide-web, a user navigates to different environments, known as web pages. On these web pages, any number of features may be present, including applets.

An applet is a small application that is often present on world-wide-web sites. Applets are typically also shipped with an operating system or other product, such as the calculator application that is shipped with Microsoft Windows® operating systems. Applets on world-wide-web sites are often written in a programming language known as Java. Java is a platform-independent programming language. Java programs are commonly referred to as applets since they are most often used for small, transportable programs.

Applets are commonly loaded into a web browser when a user is navigating web pages. The applets may modify their own user interfaces. Applications taking the form of software stored on the hard drive of a computer also have graphical user interfaces for control of the applications. These user interfaces are modifiable by the user and by the program as well. However, these modifications do not result from the use of a product model. A product model can be viewed as a data representation of a business offering. It defines the necessary information that the system needs to interrogate a user and collect the appropriate data in order to fulfill a request for a business product. An example of a business product would be a financial product like an insurance policy or a brokerage account.

Therefore, it would be desirable to provide an improved user interface.

### SUMMARY

An embodiment of a system for generating a data-driven user interface comprises a network interface, a processor, and a memory. The system uses metadata defined by both a product model and an accompanying user interface model to dynamically generate a user interface. The product model is a specification for a product offering. The product model includes the properties, rules, calculations, and behaviors of a product offering. The network interface is configured to communicate with a user device over a network. The processor is coupled to the network interface and is configured to access user-interface metadata and user-interface logic stored in the memory. The user-interface metadata reflects the product model and comprises abstractions selected from the group consisting of one or more of an item, set, frame and flow. An item is a single entry on the graphical-user interface. A set is a collection of items. A frame is a collection of sets that appear on the graphical-user interface at any one time. A flow defines a transition from a first frame to a subsequent frame. A flow is responsive to one or more rules.

One embodiment of a method for developing a data-driven user interface comprises providing a product model, representing the product model in an extensible mark-up language, constructing a prototype user interface, defining user-interface metadata responsive to the product model, the user-interface metadata comprising one or more abstractions selected from the group consisting of item, set, frame, and flow, wherein a flow is responsive to one or more rules and defines a transition from a first frame to a subsequent frame, and exposing the user-interface metadata to a processor configured to provide information to a user device that renders an interactive user interface.

### BRIEF DESCRIPTION OF THE FIGURES

The systems and methods for generating a data-driven user interface can be better understood with reference to the following figures. The components within the figures are not necessarily to scale, emphasis instead being placed upon clearly illustrating the principles behind the systems and methods. Moreover, in the figures, like reference numerals designate corresponding parts throughout the different views.

FIG. 1 is a schematic diagram illustrating an embodiment of a system of network coupled computing devices.

FIG. 2 is a schematic diagram illustrating an embodiment of the interface generation system of FIG. 1.

FIG. 3 is a schematic diagram illustrating an embodiment of the user device of FIG. 1.

FIG. 4 is a schematic diagram illustrating an embodiment of the user-interface logic of FIGS. 2 and 3.

FIGS. 5A and 5B are a schematic diagram illustrating operation of the graphical-user interface presented on the user device 105 of FIG. 1.

FIG. 6 is a flow diagram illustrating an embodiment of a method for developing a data-driven user interface.

FIG. 7 is a flow diagram illustrating an embodiment of an alternative method for developing a data-driven user interface.

### DETAILED DESCRIPTION

An interface generation system dynamically configures a graphical-user interface in accordance with a product model. The product model includes the properties, rules for governing data, calculations, and behaviors of a set of one or more application programs responsible for performing a business operation, such as opening a new account (brokerage, bank, loan, credit card, insurance policy), placing an order, among others. The interface generation system generates a graphical-user interface that displays various elements and/or sets of elements grouped as a frame so that appropriate queries are displayed and correctly formatted data is submitted by the operator of a user device in communication with the interface generation system. That is, the graphical-user interface generated by the interface generation system changes in response to user inputs and in accordance with the product model so that the correct data is displayed, while ensuring that the user's data entry meets the business rules/validations embodied in the product model. Further, the graphical-user interface guides the user by not presenting invalid or conflicting choices.

The interface generation system uses metadata to generate a frame at run-time. A frame includes all the items that appear on the graphical-user interface at any one time. An interface generation system performs multiple functions to produce the graphical-user interface. The interface generation system generates an extensible mark-up language description of a particular frame from a metadata definition of the user interface. The interface generation system generates the appropriate target markup language for a particular device (e.g., HTML for a browser) using a metadata definition of the user interface. The markup language variants ease the transportation and storage of the metadata. The metadata definition of the user interface is consistent with, defers to and is bound to the product model. The user-interface metadata comprises various abstractions including an item, set, frame and flow. The user-interface metadata, in accordance with a product model, describes what can be offered, permitted choices when selecting a product and the rules/calculations required to run validations on the user's choices (e.g., cross-edits). Frame and/or screen flow is also defined in metadata and includes the ability to customize the transition from a frame to a subsequent frame at run-time.

In an application framework, the interface generation system renders the frame(s), controls frame or screen flow, binds data entered by an operator of the user interface to the application(s), delegates business rule validations to the business application framework, maintains user session data such that multiple simultaneous requests can be executed (e.g., an agent can be working on more than one customer account at the same time), and performs user interface validations. Controllers are used to control the various interface generation tasks.

The following general procedure is used to build systems that use a product model and the data-driven user interface. Typically, one or more business analysts define the product model(s). Thereafter, the product model(s) is transformed to produce an extensible mark-up language representation of the product. An interface architect constructs a prototype user interface responsive to a maximum level of information to be rendered on each frame of the interface. The prototype user interface can be constructed in a hypertext mark-up language. Once the prototype user interface is constructed, the prototype user interface is transformed into an extensible mark-up language or an internal run-time format. Thereafter, the data-driven user interface can be customized through well-defined extension points in the user-interface generation system.

In one embodiment, the data-driven user interface is implemented via a browser application operable on a user device. Other embodiments are possible. Other types of markup specific to various end user devices such as WML, DHTML, cHTML, or even Voice XML if other end-user devices are to be supported. An execution cycle is performed as follows. A request to display a frame is received from the client application or as a forward from another page or frame after it is processed. Before the display request is processed, a navigation servlet or navlet can be configured per frame to process special logic to amend, strike or otherwise direct frame flow. Once any navlets are executed to completion, any pre-processes assigned to the current frame are executed. Processes allow arbitrary execution of code while using the graphical-user interface. Navlets and processes are examples of extension points. The data-driven user interface frame definition is retrieved and the mark-up is generated using the business application framework to execute rules and calculations to determine what frame elements should be displayed (i.e., availability) and how they should be displayed (i.e., composition). In other words, the product model as described by the user-interface metadata is used at run time to build a dynamic interface in response to the data that the user has entered. The resulting markup is returned to the browser application.

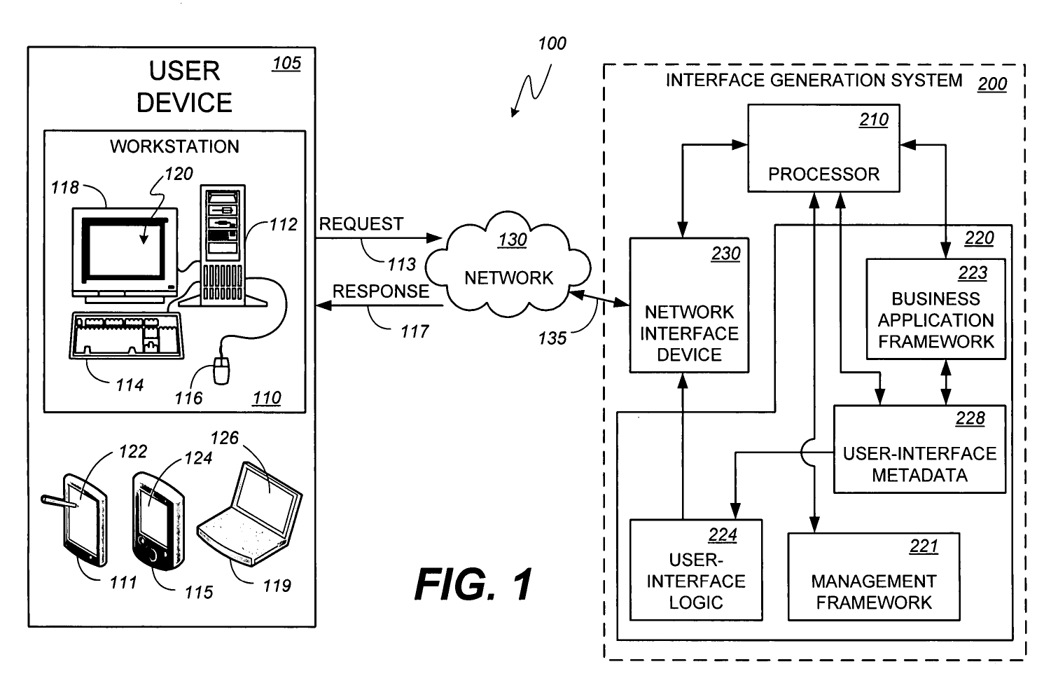

The operator of the user device interacts with the frame via one or more input devices and submits the frame via one or more mechanisms. If specified in the metadata, user interface validations are performed on the incoming data fields. When validation errors are present, the frame is updated with the fields from the original request along with corresponding error indicators. When no validation errors are present or when data validation is not desired, the data is populated in a user-specific store. Thereafter, business application framework rules can be applied to the user data. When business validations are executed and errors are present, then the errors are displayed as appropriate. Once corrected, the data may be permanently stored in the business data store. Thereafter, post processes and post navlets are executed to amend screen flow or compute information as appropriate. Having described in general the generation and operation of the data-driven user interface, various embodiments will be described with respect to FIGS. 1-7 below.

FIG. 1 is a schematic diagram illustrating an embodiment of a system 100 for generating a data-driven user interface. System 100 includes a user device 105 coupled to interface generation system 200 via network 130. User device 105 can comprise a range of devices including workstation 110, laptop computer 119, personal digital assistant 115 and tablet computer 111. Workstation 110 comprises computer 112, and various input/output devices such as keyboard 114, mouse 116 and monitor 118. Each of the example user devices comprises a respective display for presenting a graphical-user interface to an operator of the user device 105. Monitor 118 includes a cathode-ray tube, which generates display 120. Laptop computer 119 includes a thin-film transistor active matrix display 126. Personal digital assistant 115 and tablet computer 111 include liquid crystal display 124 and liquid crystal display 122, respectively. In addition to having a display, each of the user devices includes one or more input/output mechanisms that permit an operator of the device to modify data on a graphical-user interface and to maintain a communication session via network 130 with interface generation system 200. As indicated in FIG. 1, user device 105 communicates with interface generation system 200 by sending a request 113 and receiving a response 117. As is known in the art of networking, request 113 is transported across network 130 to interface generation system 200 where the request is received, processed and a response is generated and transmitted back to the respective user device that initiated the request.

Interface generation system 200 is a computing device that comprises processor 210, memory 220 and network interface device 230. Interface generation system 200 is coupled to network 130 via connection 135 through network interface device 230. Memory 220 includes management framework 221, application framework 223, user-interface logic 224 and user-interface metadata 228. Processor 210 communicates with locations in memory 220 assigned to management framework 221, business application framework 223 and user-interface metadata 228. User-interface metadata 228 is in communication with user-interface logic 224, which communicates with user device 105 via network-interface device 230 and network 130. The business application framework 223 manages a host of programs and data to accomplish a multitude of operational tasks. Management framework 221 includes a plurality of rules and operational parameters for supporting runtime core functionality. Management framework 221 directs file and network operations, provides access to services, manages access and interaction with data stores including user-interface metadata 228. User-interface logic 224 in the generation of a graphical-user interface that is presented on user device 105.

Business application framework 223 includes one or more client support applications. Client support applications comprise a source program, an executable program (object code), a script, or any other entity comprising a set of instructions to be performed. Client support applications support requests for information and/or information translations or other data operations.

In one embodiment, interface generation system 200 is built on a commercial off-the-shelf (COTS) Java 2 enterprise edition (J2EE) application server. Interface generation system 200 provides common processes and services, file management and data stores. Interface generation system 200 may be implemented using various technologies, including but not limited to, J2EE/Java, XML, SOAP, WSDL, UDDI, etc. A management framework 221 includes a plurality of rules and operational parameters for supporting runtime core functionality.

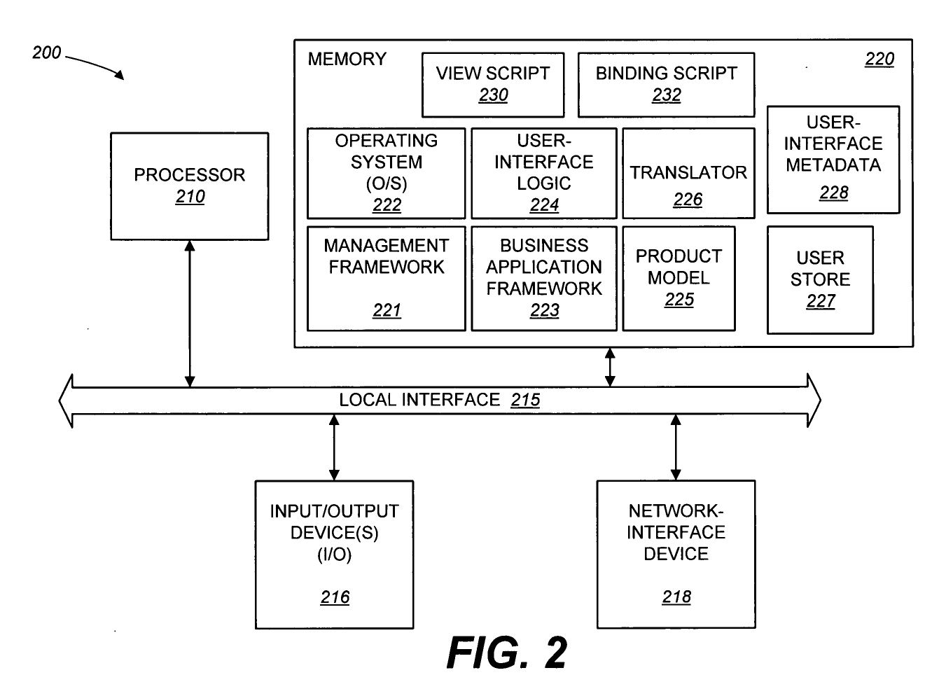

FIG. 2 is a schematic diagram illustrating an embodiment of the interface generation system 200 of FIG. 1. Generally, in terms of hardware architecture, as shown in FIG. 2, interface generation system 200 includes processor 210, memory 220 and one or more operator input and/or output (I/O) devices 216 (or peripherals) that are communicatively coupled via a local interface 215. The local interface 215 can be, for example but not limited to, one or more buses or other wired or wireless connections, as is known in the art. The local interface 215 may have additional elements, which are omitted for simplicity, such as controllers, buffers (caches), drivers, repeaters, and receivers, to enable communications. Further, the local interface 215 may include address, control, and/or data connections to enable appropriate communications among the aforementioned components.

Processor 210 is a hardware device for executing software, particularly that stored in memory 220. The processor 210 can be any custom made or commercially available processor, a central processing unit (CPU), an auxiliary processor among several processors associated with the interface generation system 200, a semiconductor based microprocessor (in the form of a microchip or chip set), or generally any device for executing software instructions.

The memory 220 can include any one or combination of volatile memory elements (e.g., random-access memory (RAM), such as dynamic random-access memory (DRAM), static random-access memory (SRAM), synchronous dynamic random-access memory (SDRAM), etc.) and nonvolatile memory elements (e.g., read-only memory (ROM), hard drive, tape, compact disc read-only memory (CDROM), etc.). Moreover, the memory 220 may incorporate electronic, magnetic, optical, and/or other types of storage media. Note that the memory 220 can have a distributed architecture, where various components are situated remote from one another, but can be accessed by the processor 210.

The software in memory 210 may include one or more separate programs, each of which comprises an ordered listing of executable instructions for implementing logical functions. In the example of FIG. 2, the software in the memory 220 includes operating system 222, business application framework 223, user-interface logic 224, and translator 226. In addition, memory 220 includes product model 225, user store 227 and user-interface metadata 228. The operating system 222 essentially controls the execution of other computer programs, such as management framework 221, business application framework 223, user-interface logic 224 and translator 226 and provides scheduling, input-output control, file and data management, memory management, and communication control and related services.

Business application framework 223 comprises one or more programs and one or more data elements such as information from user store 227 and user-interface metadata 228. Information in user store 227 includes personal information and information useful for communicating with an operator of user device 105. Product model 225 includes the properties, rules for governing data, calculations, and behaviors of a set of one or more application programs responsible for performing an operation. User-interface metadata 228 describing the user interface can be arranged in an extensible mark-up language format conforming to certain schema. Alternatively, the user interface can be described in an internal run-time format (e.g., view script 230 and binding script 232). When the data-driven user interface is defined in the extensible markup language a translator 226 configured to convert a representation into an executable format is integrated with the user-interface logic 224. Otherwise, when the data-driven user interface is defined in the run-time format, view script 230 and binding script 232 are used to describe each frame. View script 230 defines the user-interface layout, input fields, pushbuttons, style, etc. Binding script 232 supplies mapping of user-interface elements (or items) to parts of the product model 225. Binding script 232 also defines various data validators that are to be selectively applied against user entered data.

Management framework 221, business application framework 223, user-interface logic 224 and translator 226 are source programs, executable programs (object code), scripts, or any other entities comprising a set of instructions to be performed. When implemented as source programs, the programs are translated via a compiler, assembler, interpreter, or the like, which may or may not be included within the memory 220, so as to operate properly in connection with the O/S 222. Furthermore, management framework 221, business application framework 223, user-interface logic 224 and translator 226 can be written in one or more object oriented programming languages, which have classes of data and methods, or procedure programming languages, which has routines, subroutines, and/or functions. In the currently contemplated best mode, management framework 221, application framework 223, user interface logic 224 and translator 226 are implemented in software, as executable programs executed by processor 210.

I/O devices 216 may include input devices, for example but not limited to, a keyboard, mouse, scanner, microphone, etc. Furthermore, I/O devices 216 may also include output devices, for example but not limited to, a printer, display, etc. I/O devices 216 may further include devices that communicate both inputs and outputs, for instance but not limited to, a modulator/demodulator, (modem; for accessing another device, system, or network), a radio frequency (RF) or other transceiver, a telephonic interface, a bridge, a router, etc. One or more of these communication devices may be included in network-interface device 218, which enables interface generation system 200 to communicate with network coupled devices. I/O devices 216 enable a local operator to configure programs and/or data associated with interface generation system 200. Various network coupled devices with appropriate access authorization can configure programs and/or data associated with interface generation system 200 remotely.

When interface generation system 200 is in operation, the processor 210 is configured to execute software stored within the memory 220, to communicate data to and from the memory 220, and to generally control operations of the interface system 200 pursuant to the software. The management framework 221, business application framework 223, user-interface logic 224, translator 226, product model 225 and the O/S 222, in whole or in part, but typically the latter, are read by the processor 210, perhaps buffered within the processor 210, and then executed.

When the user-interface logic 224 is implemented in software, as is shown in FIG. 2, it should be noted that the user-interface logic 224 can be stored on any computer-readable medium for use by or in connection with any computer related system or method. In the context of this document, a “computer-readable medium” is an electronic, magnetic, optical, or other physical device or means that can contain or store a computer program for use by or in connection with a computer related system or method. The user-interface logic 224 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random-access memory (RAM) (electronic), a read-only memory (ROM) (electronic), an erasable programmable read-only memory (EPROM), an electrically erasable programmable read-only memory (EEPROM), or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where one or more of the management framework 221, application framework 223, user-interface logic 224 and translator 226 are implemented in hardware, the management framework 221, business application framework 223, user-interface logic 224 and translator 226 can implemented with any or a combination of the following technologies, which are each well known in the art: a discrete logic circuit(s) having logic gates for implementing logic functions upon data signals, an application-specific integrated circuit (ASIC) having appropriate combinational logic gates, a programmable gate array(s) (PGA), a field programmable gate array (FPGA), etc.

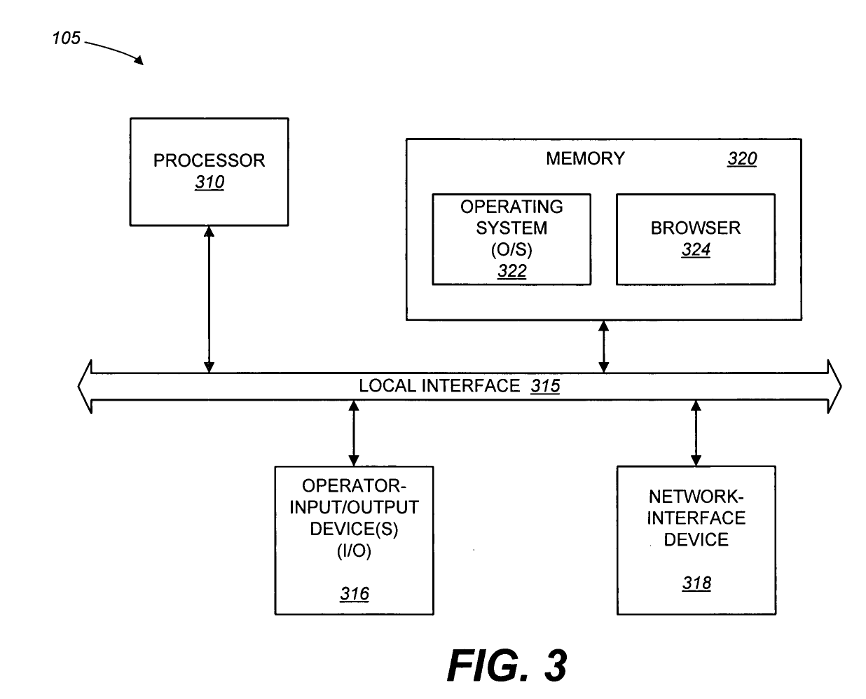

FIG. 3 is a schematic diagram illustrating an embodiment of the user device 105 of FIG. 1. Generally, in terms of hardware architecture, as shown in FIG. 3, user device 105 includes processor 310, memory 320 and one or more operator input and/or output (I/O) devices 316 (or peripherals) that are communicatively coupled via a local interface 315. The local interface 315 can be, for example but not limited to, one or more buses or other wired or wireless connections, as is known in the art. The local interface 315 may have additional elements, which are omitted for simplicity, such as controllers, buffers (caches), drivers, repeaters, and receivers, to enable communications. Further, the local interface 315 may include address, control, and/or data connections to enable appropriate communications among the aforementioned components.

Processor 310 is a hardware device for executing software, particularly that stored in memory 320. The processor 310 can be any device for executing software instructions. The memory 320 can include any one or combination of volatile memory elements (e.g., RAM, such as DRAM, SRAM, SDRAM, etc.)) and nonvolatile memory elements (e.g., ROM, flash memory, etc.). Moreover, the memory 320 may incorporate electronic, magnetic, optical, and/or other types of storage media. Note that the memory 320 can have a distributed architecture, where various components are situated remote from one another, but can be accessed by the processor 310.

The software in memory 320 may include one or more separate programs, each of which comprises an ordered listing of executable instructions for implementing logical functions. In the example of FIG. 3, the software in the memory 320 includes operating system 322 and browser 324. Operating system 322 essentially controls the execution of browser 324 and provides scheduling, input-output control, file and data management, memory management, and communication control and related services.

Browser 324 is a source program, executable program (object code), script, or any other entity comprising a set of instructions to be performed. Browser 324 delegates user interface processing to interface generation system 200. When implemented as a source program, browser 324 is translated via a compiler, assembler, interpreter, or the like, which may or may not be included within the memory 320, so as to operate properly in connection with the O/S 322. Furthermore, browser 324 can be written in one or more object oriented programming languages, which have classes of data and methods, or procedure programming languages, which have routines, subroutines, and/or functions.

The operator I/O devices 316 may include input devices, for example but not limited to, a keyboard, mouse, scanner, microphone, a touch sensitive display etc. Furthermore, the operator I/O devices 316 may also include output devices, for example but not limited to, a printer, display, etc. I/O devices may further include devices that communicate both inputs and outputs, for instance but not limited to, a modulator/demodulator (modem; for accessing another device, system, or network), a radio frequency (RF) or other transceiver, a telephonic interface, a bridge, a router, etc. One or more of these communication devices may be included in network interface device 318, which enables user device 105 to communicate with network coupled devices such as interface generation system 200.

When user device 105 is in operation, the processor 310 is configured to execute software stored within the memory 320, to communicate data to and from the memory 320, and to generally control operations of the user device 105 pursuant to the software. Browser 324 and O/S 322, in whole or in part, but typically the latter, are read by the processor 310, perhaps buffered within the processor 310, and then executed. It should be understood that browser 324 can be stored on any computer-readable medium for use by or in connection with any computer related system or method.

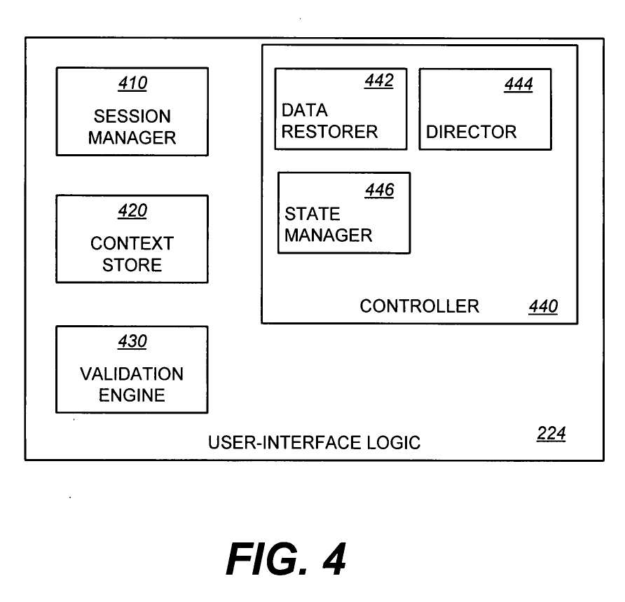

FIG. 4 is a schematic diagram illustrating an embodiment of the user-interface logic 224 of FIG. 2. The user-interface logic 224 comprises an ordered listing of executable instructions for implementing logical functions. In the example of FIG. 4, the software includes session manager 410, validation engine 430 and controller 440. Controller 440 includes a collection of filters or a filter chain. The filter chain comprises one or more filters configured to restore data to a session, govern a state machine, and direct the execution of one or more processes. Controller 440 includes data restorer 442, director 444, and state manager 446.

The session manager 410 is configured to enable operators to create and delete sessions and to retrieve, set and remove attributes within a session. The session manager 410 manages data used to execute requests within a J2EE session. Data comprises the operator's request, a product and version identifier associated with the request, a user-interface context 420 associated with the request, and a frame history. The frame history includes a record of the pages traversed by the operator during the present session. This collection of data is stored by session manager 410. Since it is possible for a user to have two or more applications running simultaneously that use the data-driven user interface and business application framework 223, the session data is indexed by the session identifier.

User-interface context store 420 is configured to hold the state of the user interface when a user is working on a request. The user-interface context is associated with the present session. The user-interface context store 420 allows the user interface logic 224 to communicate relevant information, permits a change of state of the user interface (e.g., to change the frame flow) and provides a data store for information that is not immediately pertinent to the rendered information on the interface but is needed to manage flow.

Validation engine 430 is configured to apply one or more data collection rules on an item basis. Depending on the item type, the validation engine 430 has at least the following example validators available: required, date, integer, string length, range, regular expression, precision, and postal code. The required validator ensures that an associated field was filled-in by an operator of the interface. The date validator checks the validity of the date and is supplemented with a regular expression format check when a strict date entry is required. The integer validator checks to make sure data is entered in the field is an integer. The string length validator ensures that text entry falls within a min./max. character length range. The range validator checks to make sure numbers fall within a designated range. The regular expression validator compares entered text against a designated regular expression. The precision validator ensures the precision of a number falls within the bounds of a specified precision. The postal code validator checks the format of the postal code against one or more accepted formats. Any particular user-interface item can have none to many validators applied. Once validation has completed, any errors are collected in a list using default error templates or by using custom error messages provided in the metadata.

Data restorer 442 restores and saves data. Data restorer 442 restores data when beginning a request and saves data at the end of processing the request. Director 444 handles the execution of pre-processes and post-processes to be performed against user interface items. Processes include custom functions (special logic, business rules, mechanisms for external system access, etc.) that can be enabled during execution of the user interface. Processes are defined within the interface generation system 200 in the product model 225 or the user-interface metadata 228. A process is defined on a per-frame basis and can be executed before the frame is displayed, as a pre-process, or after the frame is displayed, as a post-frame process. The interface generation system 200 is appraised of both pre-processes and post-processes by their presence in the user-interface metadata 228. State manager 446 is configured to execute pre-frame navlets and post-frame navlets to manage frame flows by changing the state of the user interface.

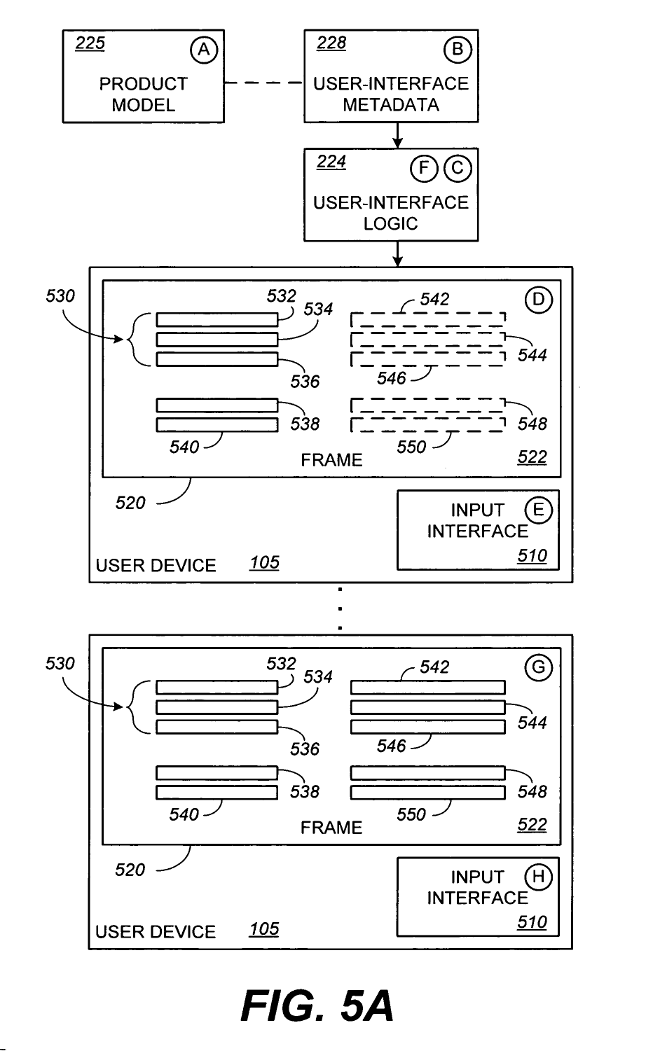

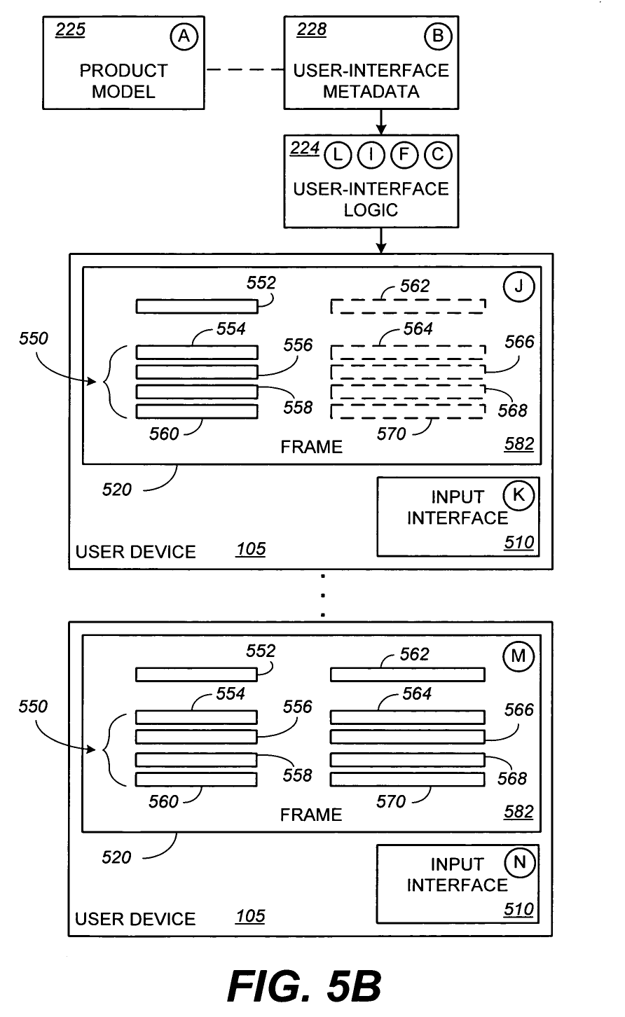

FIGS. 5A and 5B include a schematic diagram illustrating operation of the graphical-user interface presented on the user device 105 of FIG. 1. The schematic diagram includes a sequence of encircled letters A through N that indicate the order of operation of interface generation system 200. As illustrated in FIG. SA, product model 225, labeled “A,” is used to develop user-interface metadata 228. As described above, user-interface metadata 228 defers to and is bound to the product model 225 and comprises various abstractions. User-interface metadata 228, labeled “B,” describes all items and sets available for each frame. When the data-driven user interface is defined in the extensible markup language, translator 226 (FIG. 2) converts a representation into an executable format. Otherwise, when the data-driven user interface is defined in a run-time format, view script 230 and binding script 232 (FIG. 2) are used to describe each frame. View script 230 defines the user-interface layout, input fields, pushbuttons, style, etc. Binding script 232 supplies mapping of user-interface elements (or items) to parts of the product model 225. Binding script 232 also defines various data validators that are to be selectively applied against user entered data.

User-interface logic 224, labeled “C,” generates commands that are forwarded to user device 105, which renders frame 522 on display 520. User-interface logic 224 generates the commands in accordance with a present context. In the illustrated embodiment, user-interface logic 224 directs user device 105 to render multiple items within frame 522, labeled “D.” Item 532, item 534 and item 536 are associated with set 530. In some embodiments, items 532 through 540 may include information that indicates to an operator of user device 105 that they are to enter a street address, a suite or apartment number, city, state and postal code, respectively. Input interface 510, labeled “E,” is used by the operator to enter appropriate information in various data entry fields within frame 522. Field 542 is arranged to receive the operator's street address. Field 544 is arranged to receive a suite or apartment number, Field 546 is arranged to receive a city name. Field 548 is arranged to receive the name of a state or a state code. Field 550 is arranged to receive a postal code. User-interface logic 224, labeled “F,” receives the operator inputs entered via input interface 510.

Frame 522, labeled “G,” illustrates the state of the data-driven user interface after the operator has completed each of the data entry fields. In operative embodiments, frame 522 will include one or more input selectors that direct the user-interface logic 224 to validate and submit the operator entered data. User interface 510, labeled “H,” is used to enable the operator to communicate the selection of one or more data validators or the data submission operation. In response, user-interface logic 224, labeled “I” on FIG. 5B, uses the entered data and user-interface context to generate a subsequent frame 582, labeled, “J.”

Frame 582 includes set 550 and element 552 and associated data entry fields. Set 550 includes element 554, element 556, element 558 and element 560. In some embodiments, items 554 through 560 may include information that indicates to an operator of user device 105 that they are to enter an opening balance for a brokerage account, a first investment option, a first investment amount, a second investment option and a second investment amount, respectively. Input interface 510, labeled “K,” is used by the operator to enter appropriate information in various data entry fields within frame 582. Field 562 is arranged to receive the opening balance for the account. Field 564 is arranged to receive a first investment name or symbol. Field 566 is arranged to receive a first investment amount. Field 568 is arranged to receive a second investment name or symbol. Field 570 is arranged to receive a second investment amount. User-interface logic 224, labeled “L,” receives the operator inputs entered via input interface 510.

Frame 582, labeled “M,” illustrates the state of the data-driven user interface after the operator has completed each of the data entry fields. In operative embodiments, frame 582 will include one or more input selectors that direct the user-interface logic 224 to validate and submit the operator entered data. For example, for frame 582 validators may be configured to authenticate the name or symbol entered to identify a particular investment option. In addition, the first and second investment amounts can be added and checked to ensure that the sum does not exceed the opening account balance. User interface 510, labeled “N,” is used to enable the operator to communicate the selection of one or more data validators or the data submission operation. In response, user-interface logic 224, uses the entered data and user-interface context to generate a subsequent frame (not shown). The above-described process can be repeated as desired to complete an interactive task of collecting and validating operator provided data.

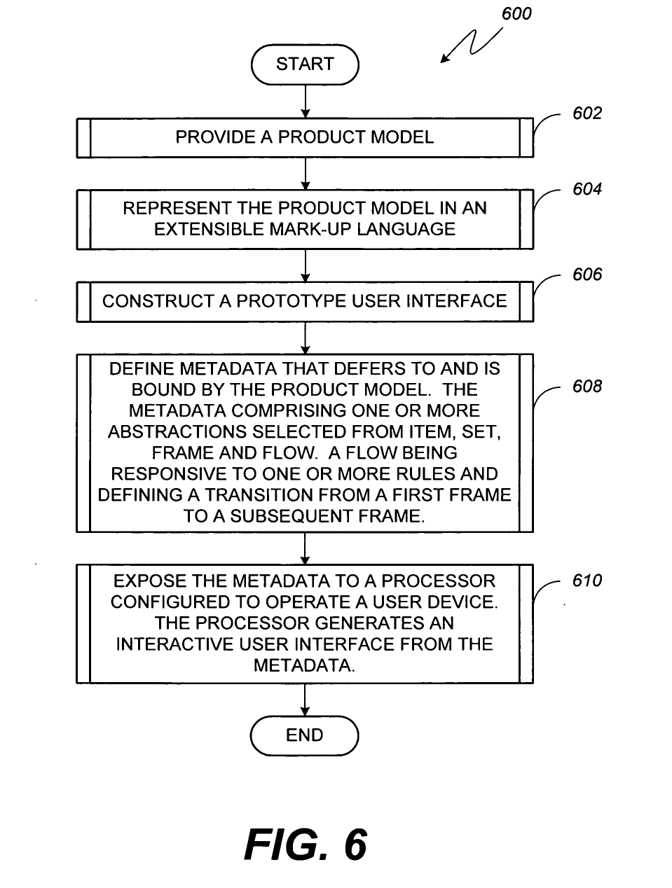

FIG. 6 is a flow diagram illustrating an embodiment of a method 600 for developing a data-driven user interface. Method 600 begins with block 602 where a product model is provided. In block 604 the product model is represented in an extensible mark-up language. In block 606 a prototype user interface is constructed. As described above, the prototype user interface includes items that may be presented in one or more frames of the user interface. In block 608, user-interface metadata that refers to or binds to the product model is defined. The metadata comprises various abstractions of elements that are used to render a graphical-user interface. The abstractions include an item, a set, a subset, a frame, and a flow. A flow defines a transition from a first frame to a subsequent frame. A flow is responsive to one or more business rules. A frame is a collection of items that appear on the graphical-user interface at any one time. A set is a collection of items. An item is a single entry on the graphical-user interface. In block 610, the metadata is exposed to a processor configured to operate a user device. The processor generates an interactive user interface from the metadata.

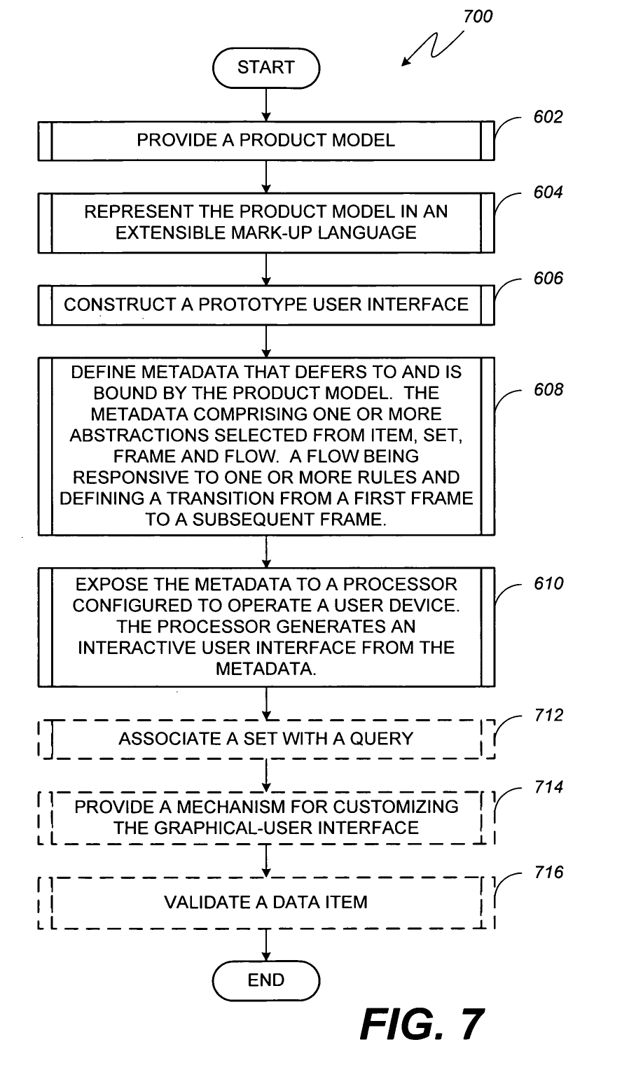

FIG. 7 is a flow diagram illustrating an embodiment of an alternative method for developing a data-driven user interface. Method 600 begins with block 602 where a product model is provided. In block 604, the product model is represented in an extensible mark-up language. In block 606, a prototype user interface is constructed. As described above, the prototype user interface includes items that may be presented in one or more frames of the user interface. In block 608, user-interface metadata that refers to or binds to the product model is defined. The user-interface metadata comprises various abstractions of elements that are used to render a graphical-user interface. The abstractions include an item, a set, a subset, a frame, and a flow. An item is a single entry on the graphical-user interface. A set is a collection of one or more items. A frame is a collection of items that appear on the graphical-user interface at any one time. A flow defines a transition from a first frame to a subsequent frame. A flow is responsive to one or more business rules. In block 610, the metadata is exposed to a processor configured to operate a user device. The processor generates an interactive user interface from the metadata. In block 712, a set is associated with a query. In block 714, a mechanism is provided for customizing the graphical-user interface. In block 716, a data item is validated.

Any process descriptions or blocks in the flowcharts of FIGS. 6 and 7 should be understood as representing modules, segments, or portions of code which include one or more executable instructions for implementing specific logical functions or steps in the methods for developing a data-driven user interface. Alternate implementations are within the scope of the data-driven user interface in which functions may be executed out of order from that shown or discussed, including substantially concurrently or in reverse order, and/or manually, depending on the functionality involved, as would be understood by those reasonably skilled in the art.

The systems and methods for developing a data-driven user interface are defined by the appended claims. The foregoing description has been presented for purposes of illustration and description to enable one of ordinary skill to make and use the systems and methods for developing a data-driven user interface. The foregoing description is not intended to be exhaustive or to limit the scope of the claims to the precise forms disclosed. Rather, a person skilled in the art will construe the appended claims broadly, to include other variants and embodiments of the invention, which those skilled in the art may make or use without departing from the claimed systems and methods and their equivalents.

What is claimed is:

1. A method for developing a data-driven user interface, comprising:
providing a product model;
representing the product model in an extensible mark-up language;
constructing a prototype user interface;
defining user-interface metadata that defers to the product model, the user-interface metadata comprising one or more abstractions selected from the group consisting of item, set, frame, and flow, wherein a flow is responsive to one or more rules and defines a transition from a first frame to a subsequent frame; and
exposing the user-interface metadata to a processor configured to provide information to a user device that renders a dynamic and interactive graphical-user interface derived from the user-interface metadata.

2. The method of claim 1, wherein defining user-interface metadata comprises introducing a query.

3. The method of claim 2, further comprising:
associating a set with the query.

4. The method of claim 1, wherein the business rule is responsive to a mathematical calculation.

5. The method of claim 1, further comprising:
providing a mechanism for modifying the dynamic and interactive graphical-user interface.

6. The method of claim 5, wherein the mechanism is selected from the group consisting of session management, context management, and filtering.

7. The method of claim 6, wherein filtering comprises one or more of restoring data to a session, governing a state machine, and directing the execution of one or more processes.

8. The method of claim 5, further comprising:
validating a data item.

9. A system for generating a data-driven user interface, the system comprising:
a network interface configured to communicate with a user device;
a processor coupled to the network interface; and
a memory coupled to the processor, the memory comprising user-interface logic and metadata that mirrors a product model, the user-interface logic being driven by the metadata to generate a dynamic user interface on the user device, the metadata comprising one or more abstractions selected from the group consisting of item, set, frame, and flow, wherein a flow is responsive to one or more rules and defines a transition from a first frame to a subsequent frame.

10. The system of claim 9, wherein the user-interface logic comprises a session manager, a content manager, and a filter chain.

11. The system of claim 10, wherein the filter chain comprises one or more filters configured to perform one or more of restoring data to a session, governing a state machine, and directing the execution of one or more processes.

12. The system of claim 9, wherein the user-interface logic comprises a validation engine.

13. The system of claim 12, wherein results generated by the validation engine are presented in a scrollable list with hyperlinks to a location associated with an error.

14. The system of claim 9, wherein the metadata defines the user interface for each item, set, subset, frame, sub-frame as if each possibility will be rendered when a user application operative on the user device is executed.

15. The system of claim 9, wherein when the user-interface logic is executed, the user-interface logic assembles items, sets, and frames at run time in accordance with availability rules identified in the product model.

16. The system of claim 9, wherein when the user-interface logic is executed, the user-interface logic assembles items and sets for a particular frame in accordance with visibility conditions.

17. The system of claim 9, wherein when the user-interface logic is executed, the user-interface logic assembles menu items and entries for a set in accordance with a composition calculation from the product model.

18. The system of claim 9, wherein a data-driven user interface is defined in one of an extensible markup language interface and a run-time format.

19. The system of claim 18, wherein when the data-driven user interface is defined in the extensible markup language, a translator configured to convert a representation into an executable format is integrated with the user-interface logic.

20. The system of claim 18, wherein when the data-driven user interface is defined in the run-time format, a view script and a binding script are used to describe each frame.
